(19) United States
(12) Patent Application Publication
(10) Pub. No.: US 2023/0226623 A1
(43) Pub. Date: Jul. 20, 2023

(54) EDGE MILLING DEVICE AND EDGE MILLING COMPONENT THEREOF

(71) Applicant: VERO VERIA CORPORATION, New Taipei City (TW)

(72) Inventor: Chien-Teh HUANG, New Taipei City (TW)

(73) Assignee: VERO VERIA CORPORATION, New Taipei City (TW)

(21) Appl. No.: 18/186,645

(22) Filed: Mar. 20, 2023

Related U.S. Application Data
(63) Continuation-in-part of application No. 17/667,879, filed on Feb. 9, 2022, now abandoned.

(30) Foreign Application Priority Data
Jul. 27, 2021 (TW) 110127480
Jul. 27, 2021 (TW) 110208802

(51) Int. Cl. B23C 3/12

(52) U.S. Cl. CPC B23C 3/12

(57) ABSTRACT

An edge milling device is provided and includes a base platform having a working surface, at least one edge milling component displaceably disposed on the working surface for processing a side surface of a target object, a positioning structure disposed on the working surface for placing the target object, and a fastening portion disposed corresponding to the positioning structure to press the target object on the positioning structure, thereby speeding up the production and improving the production efficiency.

### CROSS-REFERENCE TO RELATED APPLICATION

This application is a continuation-in-part of U.S. patent application No. 17/667,879, filed on Feb. 9, 2022 and is based upon and claims the benefit of priority of the prior Taiwanese Patent Applications No. 110127480 and No. 110208802, both filed on Jul. 27, 2021. The entirety of the above-mentioned patent application is hereby incorporated by reference herein and made a part of this specification.

### BACKGROUND

### 1. Technical Field

The present disclosure relates to machine tools for processing burrs, and more particularly, to an edge milling device and an edge milling component thereof.

### 2. Description of Related Art

Nowadays, elevated floor devices are widely applied in anti-static machine rooms or clean rooms. Generally, elevated floors by die casting of aluminum alloy go through five main processes, which include moldmaking, aluminum melting, die casting, molding and trimming. However, during the molding process, many burrs occur on the surface and bottom of the elevated floors, which not only adversely affect tight attachment between the elevated floors and between the elevated floors and a platform frame, but also are not conducive to installation and bring some safety concerns for workers.

Conventionally, after the molding process, the burrs on four side surfaces of an elevated floor must be removed manually, which results in a low production efficiency and is both time and labor consuming.

Therefore, how to overcome the above-described drawbacks of the prior art has become an urgent issue in the art.

### SUMMARY

In view of the above-described drawbacks of the prior art, the present disclosure provides an edge milling component, which comprises: at least one milling tool; a support structure of a plate base body for bringing the milling tool to displace linearly; a carrying structure displaceably disposed on the support structure for carrying the milling tool, wherein the carrying structure and the milling tool are moved close to or away from a target object so as for the milling tool to perform an edge milling machining on the target object; and at least one motor integrated with the milling tool in a linear manner by a shaft coupling and disposed on the carrying structure to directly drive the milling tool by the shaft coupling.

In the aforementioned edge milling component, the support structure has a displacement direction perpendicular to a displacement direction of the carrying structure.

In the aforementioned edge milling component, the support structure has a rail and the carrying structure has at least one sliding block engaged with the rail to move on the rail, thereby causing the carrying structure to displace relative to the support structure.

In the aforementioned edge milling component, the carrying structure has a ball nut fastened thereon, and a ball screw rod is driven by another motor to rotate to drive the ball nut to move linearly, thereby bringing the carrying structure to move linearly and displacing the milling tool to a required position.

In the aforementioned edge milling component, the motor is fixed on an upper base body of a shaft coupling base by bolts, and a lower base body of the shaft coupling base is fixed on a milling head of the milling tool by bolts, the shaft coupling is disposed within the shaft coupling base to be pivotally connected to the motor and the milling head, wherein the shaft coupling is a cylindrical structure made of high vibration-absorbing material, and a rotating shaft of the motor is fixed on one end of the shaft coupling while a rotating shaft of the milling head is fixed on the other end of the shaft coupling.

The present disclosure further provides an edge milling device, which comprises: the above-described edge milling component; a base platform having a working surface, wherein the edge milling component is displaceably disposed on the working surface, and wherein the support structure is displaceably disposed on the base platform; a positioning structure disposed on the working surface for placing the target object, wherein the edge milling component is disposed at a side edge of the positioning structure to displace relative to the positioning structure and perform the edge milling machining on the target object, wherein the target object has a first surface, a second surface opposite to the first surface, a side surface adjacent to and connecting the first and second surfaces, and a flange protruding from the side surface, and each of four corners of the second surface has a foot base; and a fastening portion disposed corresponding to the positioning structure to press the target object on the positioning structure.

In the aforementioned edge milling device, the fastening portion is disposed over the positioning structure and/or outside one of diagonally opposite corners. For example, the fastening portion is pressed down or pulled up by a power source to press or separate from the second surface of the target object.

In the aforementioned edge milling device, the present disclosure further comprises a double rail structure fastened on the base platform, and a sliding base fastened on a bottom of the support structure and mounted on the double rail structure, wherein the sliding base slides on the double rail structure, thereby bringing the support structure to move linearly.

In the aforementioned edge milling device, the support structure has a ball nut fastened thereon, and a ball screw rod is driven by a first motor to rotate to bring the ball nut to move linearly, thereby causing the support structure to move linearly along an edge of the positioning structure relative to the base platform and the milling tool to displace linearly along the side surface of the target object to process the flange of the target object.

In the aforementioned edge milling device, the present disclosure further comprises a sliding rail disposed on the working surface of the base platform for guiding the support structure to displace.

In the aforementioned edge milling device, the present disclosure further comprises at least one power unit disposed on the base platform, wherein the power unit comprises a first motor for driving the support structure to displace and a second motor for driving the carrying structure to displace.

In summary, in the edge milling device and the edge milling component thereof according to the present disclosure, by driving the milling tool via the servo motor, the edge milling component can remove burrs on a side surface of a target object such as an elevated floor, thus speeding up the production, improving the production efficiency and reducing the labor cost.

### BRIEF DESCRIPTION OF DRAWINGS

FIG. 1A-1 is a schematic front perspective view of an edge milling device applied to a machining apparatus according to the present disclosure.

FIG. 1A-2 is a schematic rear perspective view of FIG. 1A-1.

FIG. 1B-1 is a schematic perspective view of a transport device of the machining apparatus of FIG. 1A-1.

FIG. 1B-2 is a schematic partially-enlarged perspective view of FIG. 1B-1.

FIG. 1B-3 is a schematic front plan view of another embodiment of FIG. 1B-1.

FIG. 1B-4 is a schematic top plan view of FIG. 1B-3

FIG. 1C-1 is a schematic top perspective view of a target object to be processed by the machining apparatus of FIG. 1A-1.

FIG. 1C-2 is a schematic bottom perspective view of FIG. 1C-1.

FIG. 1C-3 is a schematic side plan view of FIG. 1C-1.

FIG. 1D is a schematic side plan view of the target object that is already processed by the machining apparatus of FIG. 1A-1.

FIG. 2A-1 is a schematic perspective view of an edge milling device according to the present disclosure.

FIG. 2A-2 is a schematic partially exploded perspective view of FIG. 2A-1.

FIG. 2A-3 is a schematic partially exploded perspective view of FIG. 2A-1.

FIG. 2B is a schematic top plan view of FIG. 2A-1.

FIG. 2C is a schematic side plan view of FIG. 2A-1.

FIG. 2D is a schematic partially-enlarged perspective view of FIG. 2A-1.

FIG. 2E is a schematic partially planar perspective view of FIG. 2A-1.

### DETAILED DESCRIPTION

The following illustrative embodiments are provided to illustrate the present disclosure, these and other advantages and effects can be apparent to those in the art after reading this specification.

It should be noted that all the drawings are not intended to limit the present disclosure. Various modifications and variations can be made without departing from the spirit of the present disclosure. Further, terms such as “up,” “down,” “front,” “rear,” “left,” “right,” “a,” etc. are for illustrative purposes and should not be construed to limit the scope of the present disclosure.

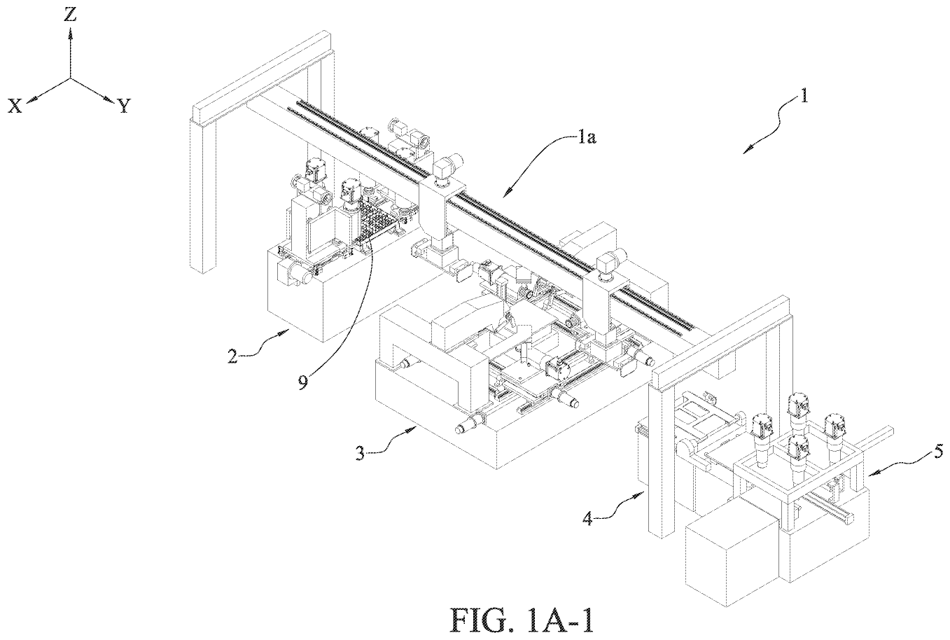

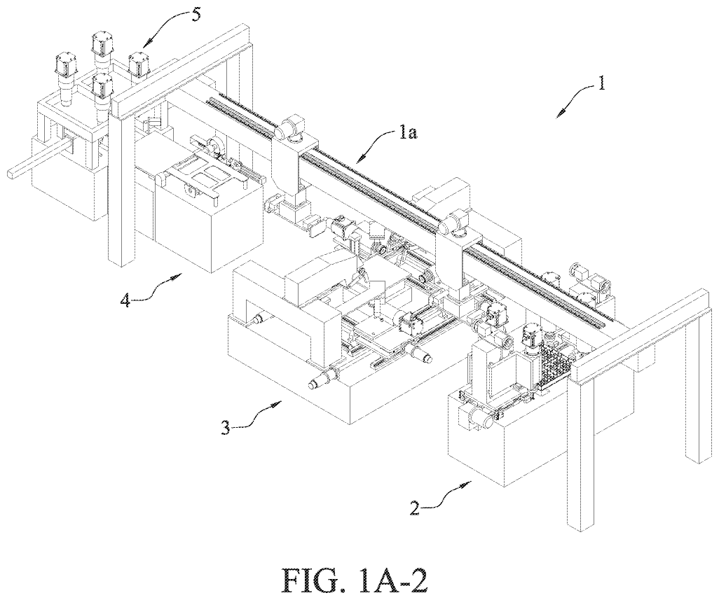

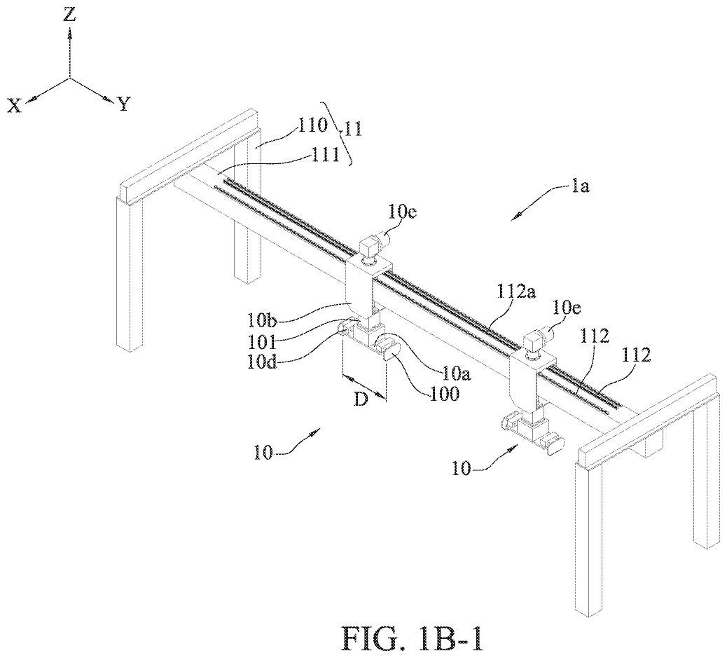

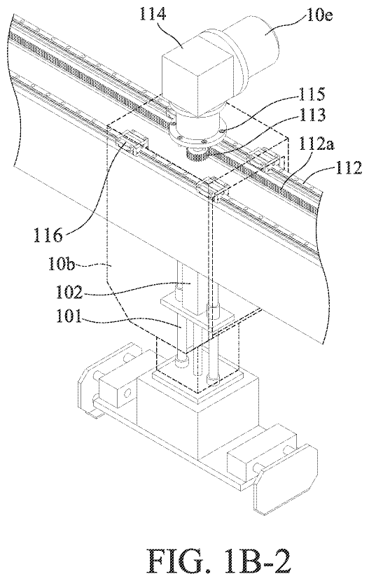

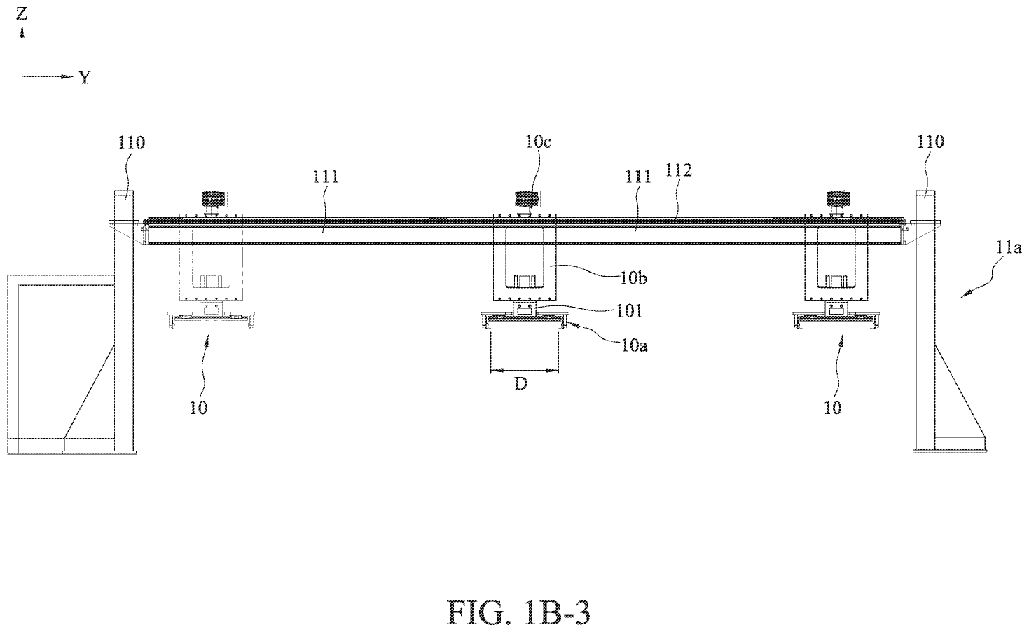

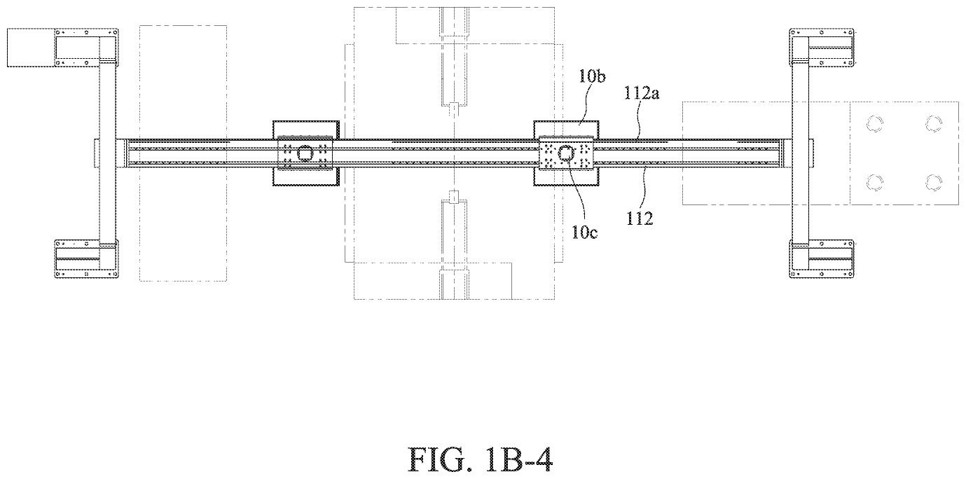

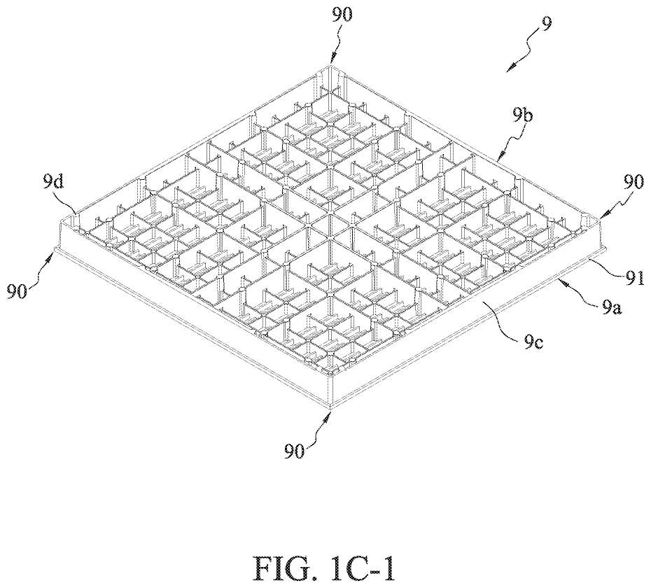

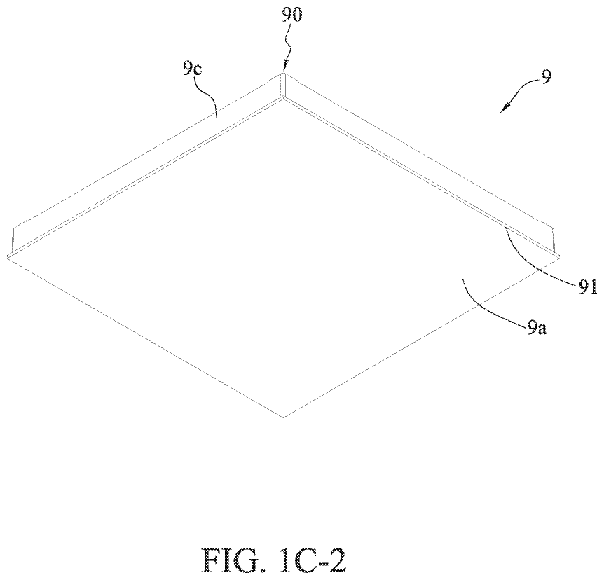

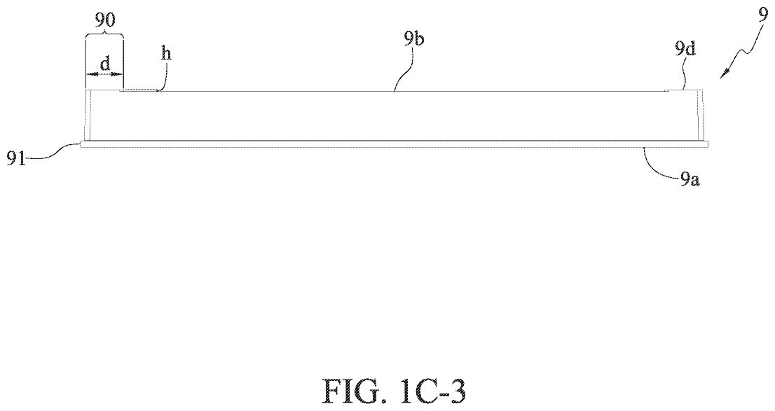

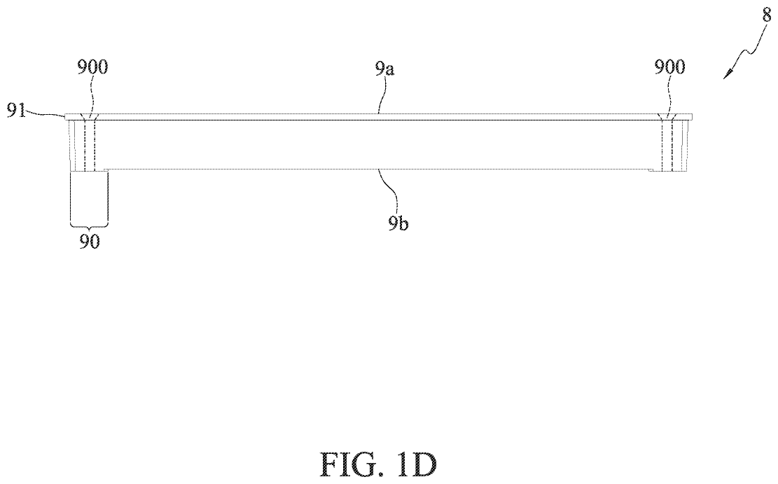

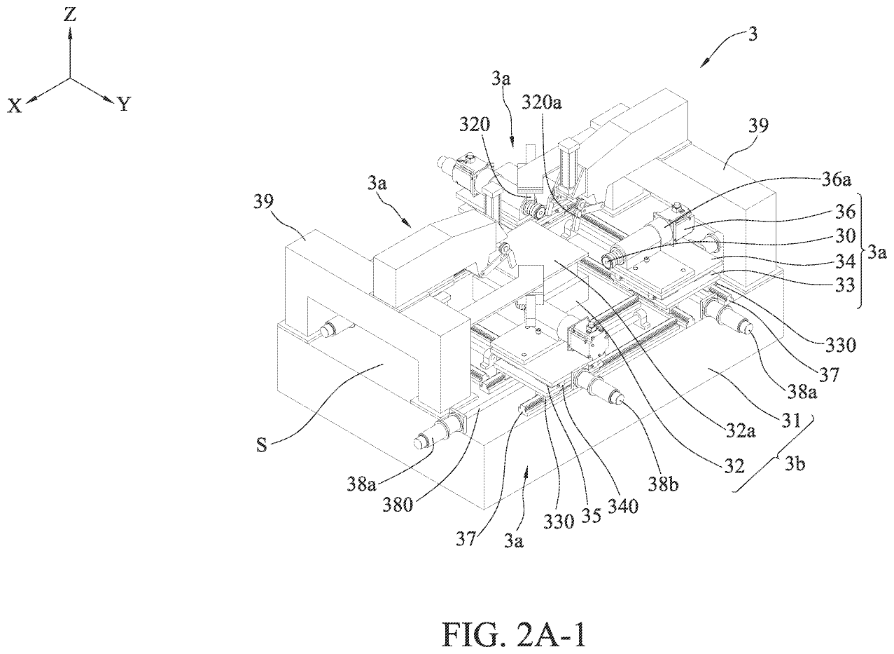

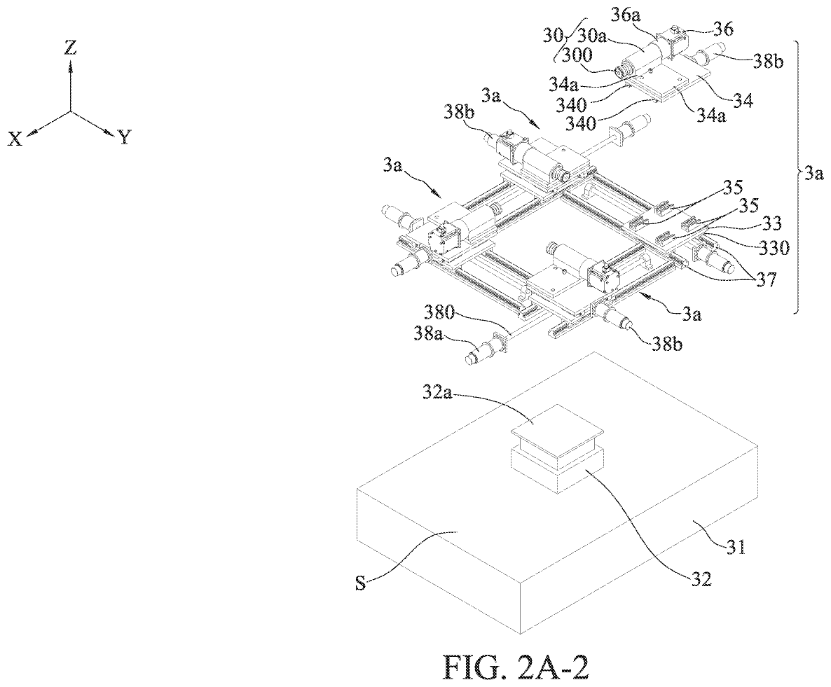

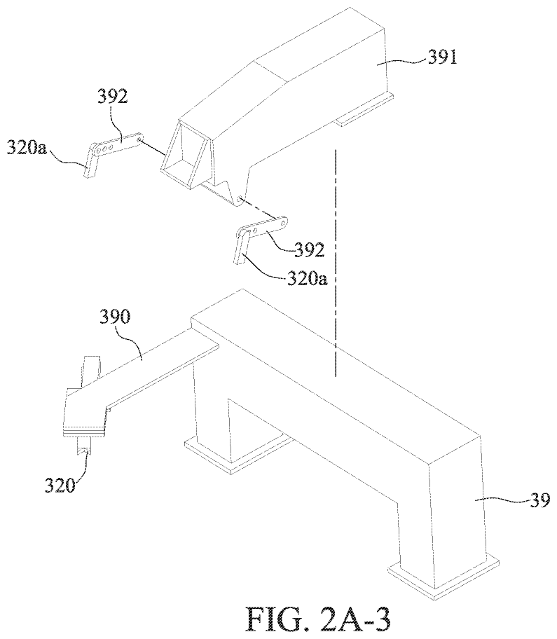

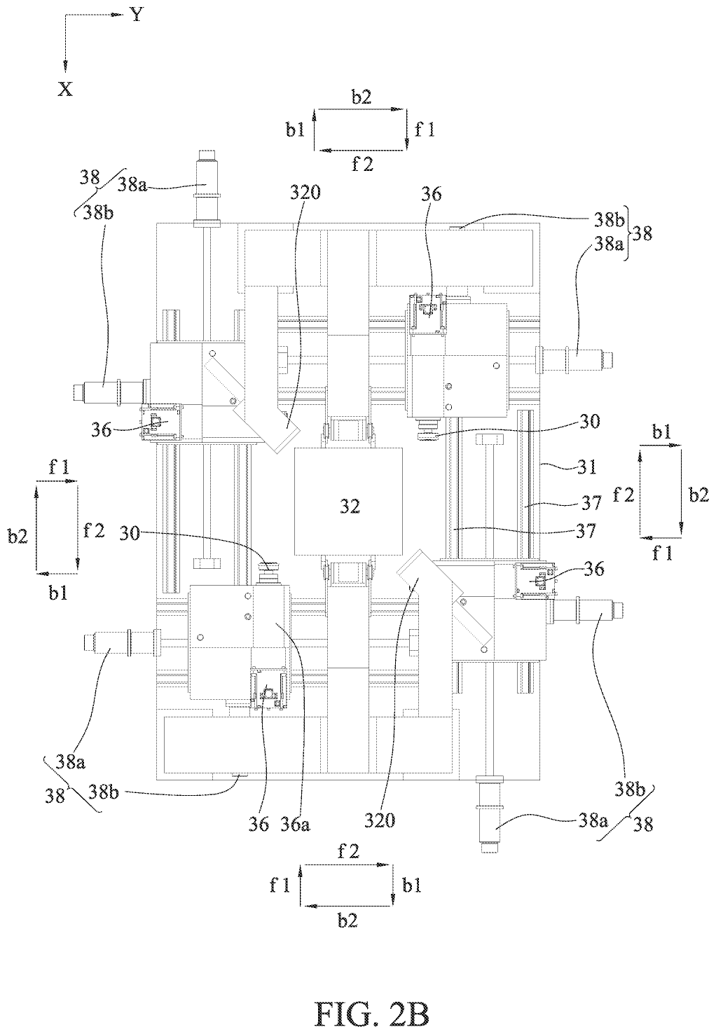

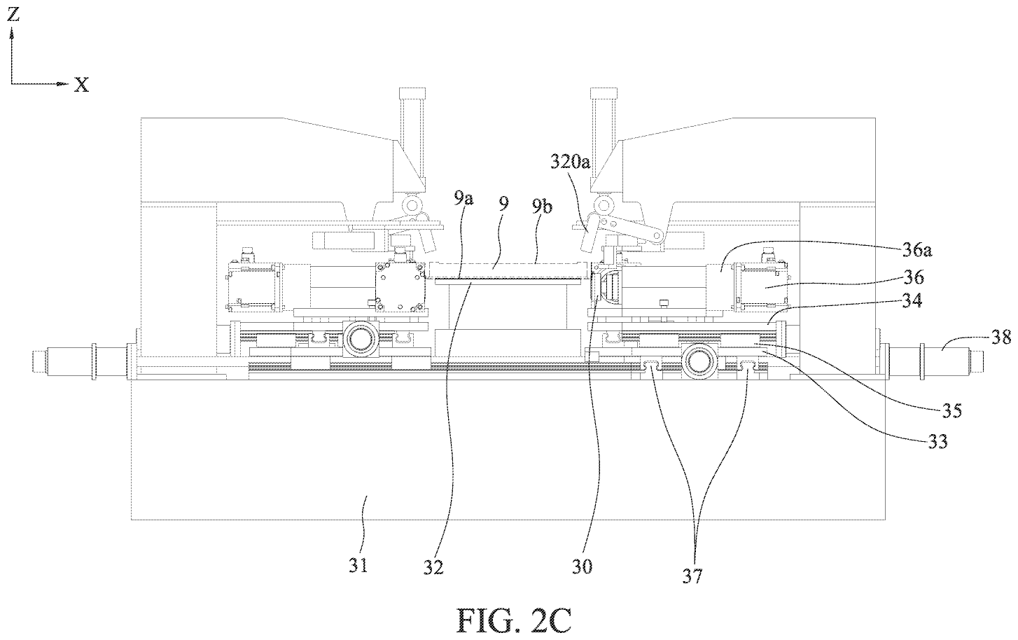

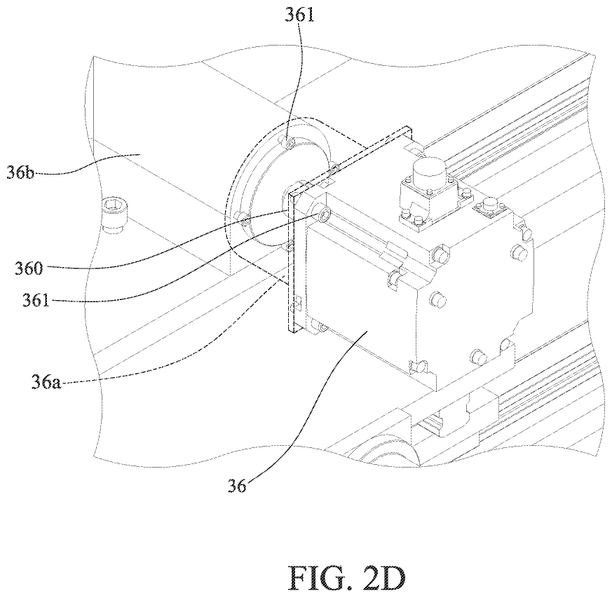

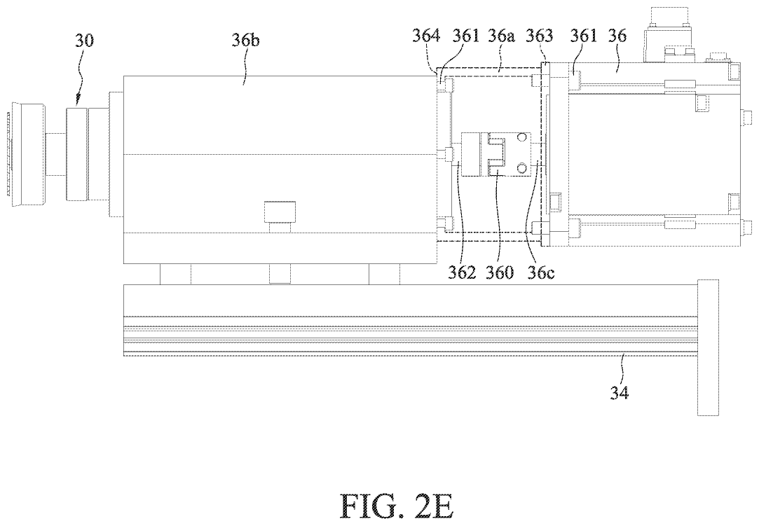

FIGS. 1A-1 and 1A-2 are schematic perspective views of a machining apparatus 1 according to the present disclosure. Referring to FIGS. 1A-1 and 1A-2, the machining apparatus 1 includes a transport device 1a, a height milling device 2, an edge milling device 3, a flipping device 4 and a hole forming device 5.

In an embodiment, for the machining apparatus 1 and for purpose of illustration, the direction of the production line is defined as a left or right direction (e.g., an arrow direction Y), a direction perpendicular to the production line is defined as a front or rear direction (e.g., an arrow direction X), and the height direction along the machining apparatus 1 is defined as a top or bottom direction (e.g., an arrow direction Z). It should be understood that the aforementioned orientations are used to illustrate the arrangement of the embodiment, and the present disclosure is not limited thereto.

The transport device 1a is used to transport (e.g., grip) a target object 9 to a required machining position of the production line. To facilitate placing of the target object 9 on the height milling device 2, the edge milling device 3, the flipping device 4 and/or the hole forming device 5, the transport device 1a is disposed over the height milling device 2, the edge milling device 3, the flipping device 4 and the hole forming device 5.

In an embodiment, referring to FIG. 1B-1, the transport device 1a includes at least a picking and placing component 10 for picking and placing the target object 9, and a support component 11. The support component 11 includes two rod frames 110 and a beam 111 arranged on the two rod frames 110. The picking and placing component 10 is displaceably disposed on the support component 11 and cooperates with the support component 11 so as to move the target object 9, thereby picking and placing the target object 9.

Further, the picking and placing component 10 includes a gripping portion 10a with a holding member 100 and a carrying portion 10b for arranging the gripping portion 10a.

In an embodiment, as shown in FIG. 1B-2 (or as supporting components 11a shown in FIGS. 1B-3 and 1B-4), the beam 111 can be equipped with a sliding rail 112 and a sliding base 116 for guiding the displacement of the picking and placing component 10, wherein the sliding rail 112 is fixed on the beam 111, the sliding base 116 is fixed on the carrying portion 10b, and the sliding base 116 and the carrying portion 10b move linearly on the sliding rail 112. And the beam 11 is equipped with at least one rack 112a and a gear 113 engaged with the rack 112a and pivotally connected to the picking and placing component 10, wherein the rack 112a is fixed on the beam 111. A servo motor 10e and a decelerator 114 are fixed on the carrying portion 10b, such that the servo motor 10e or a power portion 10c rotates the gear 113 to roll along the rack 112a to displace linearly the picking and placing component 10, so that the picking and placing component 10 can be linearly stably displaced between the two rod frames 110 by the sliding rails 112. Specifically, the servo motor 10e cooperates with the decelerator 114 that is fixed (e.g., by bolts 115 shown in FIG. 1B-2) on the carrying portion 10b to rotate the gear 113. It should be understood that there are various kinds of support components 11, 11a, and the present disclosure is not limited as such.

For example, the width D of the holding member 100 of the gripping portion 10a can be adjusted according to the requirement so as to grip the target object 9 having a different width. A hydraulic or pneumatic cylinder (serving as a power source 10d) can be used to control the distance of the two gripping portions 10a so as to grip or loosen the target object 9. The carrying portion 10b is a movable frame, which is vertically disposed on the beam 111 (or the sliding rail 112) and pivotally connected to the gear 113. The gear 113 is engaged with the rack 112a (as shown in FIG. 1B-2). The gear 113 is driven by an external force (e.g., servo motor 10e) in cooperation with the decelerator 114, such that the picking and placing component 10 can move linearly back and forth in the arrow direction Y with a sliding base (e.g., the carrying portion 10b) and the sliding rail component (e.g., the sliding rail 112 and the rack 112a and gear 113 thereon). For instance, the plurality of power sources 10d (e.g., the pneumatic or hydraulic cylinder of FIG. 1B-1) drives the gripping portion 10a to bring the holding member 100 to extend outward or retract inward (in the arrow direction Y), thus producing a loosening or holding action. Further, a retractable structure 101 (as guiding rod shown in FIG. 1B-2) connected to the gripping portion 10a is disposed on the bottom of the carrying portion 10b so as to lift or descend the gripping portion 10a a by a cylinder 102.

Furthermore, the number of the picking and placing component 10 can be set according to needs. For example, the picking and placing component 10 are respectively arranged corresponding to machining positions of the height milling device 2, the edge milling device 3 and the flipping device 4 (as such, at least two sets of picking and placing components 10 are arranged). For instance, one picking and placing component 10 is arranged between the height milling device 2 and the edge milling device 3, and the other picking and placing component 10 is arranged between the edge milling device 3 and the flipping device 4. If needed, a plurality of picking and placing components 10 (as dotted line shown in FIG. 1B-3) can be added between the rod frames 110 and the height milling device 2 to serve as intermediate transferring components of the target object 9. As such, the target object 9 can be continuously picked and placed at each machining position so as to complete machining processes of the entire production line.

In addition, referring to FIGS. 1C-1, 1C-2 and 1C-3, the target object 9 is an elevated floor, which has a first surface 9a (e.g., a floor surface), a second surface 9b (e.g., a bottom end) opposite to the first surface 9a, and a side surface 9c adjacent to and connecting the first surface 9a and the second surface 9b. For example, the target object 9 is a substantially rectangular body (e.g., a square plate), the bottom of the target object 9 (i.e., the second surface 9b, which is the bottom of the elevated floor) has a honeycomb shape, and four corners of the second surface 9b of the target object 9 have four foot bases 90. Referring to FIG. 1D, holes 900 can be formed in the four foot bases 90 so as to fasten the four foot bases 90 on support legs by using screws (the support legs are used by the elevated floor). For instance, end surfaces 9d of the foot bases 90 slightly protrude from the second surface 9b of the target object 9 (with a height difference h, as shown in FIG. 1C-3), and a flange 91 is formed at an edge of the first surface 9a and protrudes from the side surface 9c. The flange 91 is the four edges of the elevated floor to be processed by the edge milling device 3. Since the target object 9 of the embodiment is an elevated floor, it is referred to as elevated floor hereinafter.

FIGS. 2A-1 to 2E are schematic views of the edge milling device 3 according to the present disclosure. In an embodiment, an edge milling component 3a of the edge milling device 3 actuates in cooperation with the transport device 1a to process the flange 91 on the side surface 9c of the target object 8, 9 (elevated floor) of FIGS. 1C-1 to 1D. The flange 91 is the four edges of the elevated floor to be quickly processed by the edge milling device 3. For example, the edge milling device 3 is used to remove the burrs on the four sides around the elevated floor so as to process the four edge dimensions of the elevated floor. For instance, by using a man-machine control interface, machining values are inputted via a programmable logic controller (PLC) so as to control the four edge dimensions of the elevated floor to be processed.

Referring to FIGS. 2A-1 to 2E, the edge milling component 3a for processing the flange 91 of the target object 9 (e.g., four edges of the target object 9) includes at least a servo motor 36 (e.g., the servo motor 36 may be used as a motor), a milling tool 30, a support structure 33, and a carrying structure 34 displaceably disposed on the support structure 33 for carrying the milling tool 30. The milling tool 30 has a body 30a and a milling cutter 300 disposed on the top of the body 30a. The target object 9 is fastened on a fastening component 3b, the fastening component 3b includes a base platform 31 and a positioning structure 32 disposed on the base platform 31. At least an edge milling component 3a is disposed on the base platform 31 and positioned around the positioning structure 32. The target object 9 is placed on the positioning structure 32 by the transport device 1a, and the edge milling component 3a is displaced relative to the positioning structure 32 so as to perform an edge milling machining on the target object 9.

The base platform 31 is a machine tool working platform, which is substantially a rectangular body and has a working surface S of a rectangular planar shape.

In an embodiment, electromechanical components such as motors, wires or other related machine units that are required by the production line can be provided in the base platform 31, and the present disclosure is not limited as such.

The positioning structure 32 is arranged in the middle of the working surface S of the base platform 31, as shown in FIG. 2A-2, so as to position and carry the target object 9 as shown in FIG. 1C-1.

In an embodiment, the positioning structure 32 is a multi-layer rectangular plate body having a square-shaped placing platform 32a disposed thereon. The elevated floor is placed on the placing platform 32a, and one of a plurality of edge milling components 3a (four edge milling components 3a are shown in the embodiment) is placed at each of four sides of the placing platform 32a.

Further, the fastening component 3b further includes at least a fastening portion 320, 320a disposed outside the placing platform 32a so as to restrict the displacement of the target object 9 and avoid deviation of the target object 9. For example, referring to FIG. 2A-3, a gantry-shaped support frame 39 is disposed on front and rear sides of the base platform 31, and the fastening portion 320 is disposed on a main frame 390 extending on the surface of the support frame 39. As such, after the target object 9 is placed on the placing platform 32a, the foot bases 90 of the target object 9 can be tightly held diagonally by a plurality of fastening portions 320, thus preventing the target object 9 from deviating during the edge milling machining.

Furthermore, the fastening portion 320a can be disposed over the placing platform 32a so as to restrict the displacement of the target object 9 and avoid deviation of the target object 9. For example, referring to FIG. 2A-3, an arm frame 391 is disposed on the support frame 39 and pivotally connected to a stand frame 392, and the fastening portion 320a is disposed on the stand frame 392. As such, after the target object 9 is placed on the placing platform 32a, by rotating the stand frame 392, the fastening portion 320a can be pressed tightly on the second surface 9b of the target object 9, thereby preventing the target object 9 from deviating during an edge milling machining.

The edge milling device 3 has at least an edge milling component 3a disposed outside each side edge (front, rear, left and right sides) of the positioning structure 32 (or the placing platform 32a).

In an embodiment, the edge milling component 3a includes the milling tool 30, the support structure 33 disposed on the base platform 31, and the carrying structure 34 disposed on the support structure 33 for carrying the milling tool 30. The milling tool 30 has the milling cutter 300 disposed on the top of the body 30a. The carrying structure 34 is displaceably disposed on the support structure 33 so as to displace the milling tool 30 to the required position. It should be understood that there are various types of the milling cutter 300, and the present disclosure is not limited as such.

Further, the support structure 33 is a plate base body, which is displaceably disposed on the working surface S of the base platform 31. For example, the working surface S of the base platform 31 has a sliding rail 37 for limiting the displacement direction of the support structure 33 and a power unit 38 for driving the support structure 33 and the carrying structure 34 to displace. For instance, the sliding rail 37 is a double rail structure fastened on the base platform 31, and a sliding base 330 for mounting on the sliding rail 37 is fastened on the bottom of the support structure 33 so as to slide on the sliding rail 37, thereby bringing (e.g., driving) the support structure 33 to displace linearly. Further, a ball nut (not shown) and a ball screw rod 380 (fastened on the working surface S of the base platform 31) engaged with the ball nut are fastened on the bottom of the support structure 33. The power unit 38 includes a first motor 38a. The ball screw rod 380 is driven by the first motor 38a to rotate, thereby driving the ball nut to move linearly. As such, the support structure 33 is linearly displaced a long distance along the edge of the positioning structure 32 relative to the base platform 31, and hence the milling tool 30 can be linearly displaced along the side surface 9c of the target object 9 so as to process the flange 91 of the target object 9.

Furthermore, the carrying structure 34 is a frame base body, which is displaceably disposed on the support structure 33 so as to cause the milling tool 30 to move close to or away from the positioning structure 32. The power unit 38 further has a second motor 38b for driving the carrying structure 34 to displace. Therein, based on one side edge of the positioning structure 32, the displacement direction of the support structure 33 (the movement direction f2, b2 as shown in FIG. 2B-1) and the displacement direction of the carrying structure 34 (the movement direction f1, b1 as shown in FIG. 2B-1) are perpendicular to one another. For instance, a rail 35 is disposed at the upper side of the support structure 33, and a sliding block 340 disposed below the carrying structure 34 is cooperating with the rail 35 so as to move on the rail 35, thus allowing the second motor 38b to drive the carrying structure 34 to move linearly a short distance along the rail 35 relative to the support structure 33. Therefore, the milling tool 30 can move linearly to the required planar position or machining position so as to be close to or away from the positioning structure 32. For instance, a ball nut (not shown) is fastened on the lower side of the carrying structure 34, and a ball screw rod (not shown) engaged with the ball nut is fastened onto the support structure 33 and rotated by the second motor 38b. Since the ball screw rod merely rotates in place without moving, the ball nut is actuated by the ball screw rod so as to displace linearly. Hence, the carrying structure 34 is driven by the ball nut to displace linearly along the rail 35, and the milling tool 30 is linearly displaced to the required machining position.

In addition, the servo motor 36 and the milling tool 30 are disposed on the carrying structure 34 via a stand frame 34a, and the servo motor 36 and the milling tool 30 are integrated linearly so as to reduce the volume of the carrying structure 34. The milling tool 30 is directly driven by the servo motor 36 to rotate so as to allow the milling cutter 300 at the target position (e.g., attach to the flange 91 of the side surface 9c of the target object 9) to remove the burrs of the flange 91 of the target object 9. For instance, the milling tool 30 and the servo motor 36 driving the milling tool 30 to rotate are disposed on the carrying structure 34. Referring to FIGS. 2D and 2E, the servo motor 36 is fixed on an upper base body 363 of a shaft coupling base 36a by bolts 361, and a lower base body 364 of the shaft coupling base 36a is fixed on a milling head 36b of the milling tool 30 by bolts 361, so as to drive the milling tool 30 to rotate, so that the milling tool 30 removes the burrs of the flange 91 of the target object 9 at the target position (as the position abuts the flange 91 of the side surface 9c of the target object 9). And in the shaft coupling base 36a, a shaft coupling 360 is pivotally connected to the servo motor 36 and the milling head 36b, the shaft coupling 360 is a cylindrical structure made of high vibration-absorbing material, such that a rotating shaft 36c of the servo motor 36 is fixed on one end of the shaft coupling 360 while a rotating shaft 362 of the milling head 36b is fixed on the other end of the shaft coupling 360.

Therefore, the present disclosure is characterized in that the servo motor 36 directly drives the milling tool 30 to rotate, which not only reduces the volume of the edge milling device 3, but also improves the machining precision and machining speed via digital control of rotation of the servo motor 36. The conventional motor driving of the prior art cannot achieve such an efficiency.

When the edge milling device 3 is used on the production line, after the height milling machining is completed, the transport device 1a transports a single target object 9 from the height milling device 2 to the placing platform 32a of the positioning structure 32 of the edge milling device 3, and the fastening portions 320, 320a abut against the target object 9 so as to fasten the target object 9. Therein, the first surface 9a of the target object 9 faces the placing platform 32a, and the second surface 9b of the target object 9 faces upward.

Thereafter, through the second motor 38b, the carrying structure 34 is displaced close to (in the movement direction f1 of FIG. 2B) the positioning structure 32 (or the placing platform 32a) so as to displace the edge milling component 3a to the required position. Then, through the first motor 38a, the support structure 33 slides linearly along the sliding rail 37 (in the movement direction f2 of FIG. 2B) so as to move the milling tool 30. As such, the servo motor 36 drives the milling cutter 300 of the milling tool 30 to mill the burrs of the flanges 91 of the four side surfaces 9c of the target object 9, and hence the edge milling component 3a performs the edge milling machining on the target object 9 corresponding to each edge of the positioning structure 32 (or the placing platform 32a).

Thereafter, through the second motor 38b, the carrying structure 34 is displaced away (in the movement direction b1 of FIG. 2B) from the positioning structure 32 (or the placing platform 32a) so as to displace the milling tool 30 to the required position. Then, the first motor 38a drives the support structure 33 to slide linearly along the sliding rail 37 (in the movement direction b2 of FIG. 2B), thus moving the edge milling component 3a back to the original place.

In summary, in the edge milling device 3 according to the present disclosure, the servo motor 36 drives the milling tool 30 to cause the edge milling component 3a to process the burrs of the flange 91 on the side surface 9c of the elevated floor, thereby speeding up the production, improving the production efficiency and reducing the labor cost.

Further, through design of the loop-type displacement of the edge milling component 3a (in the movement directions f1, f2, b1, b2 of FIG. 2B), the present disclosure prevents the milling cutter 300 of the milling tool 30 from repeatedly milling the flange 91 on the same side surface 9c so as to avoid excessive milling of the flange 91 on the side surface 9c of the target object 9 that otherwise may damage the flange 91 or cause the milling cutter 300 to induce mechanical noise.

Moreover, the servo motor 36 is driven by the shaft coupling 360 to reduce vibration efficiently, so that the milling device 3 can reduce noise during the operation. For example, compared to the conventional belt-driven motor, the servo motor 36 is integrated with the milling tool 30 in a linear manner by the shaft coupling 360, which not only reduces the conventional transmission mechanism that requires the configuration of two pulleys and belts (i.e., the conventional motor uses pulleys to drive the milling tool to rotate for processing), but also apparently reduces the volume, and greatly improves the precision, further reduces the vibration and noise issues generated by the drive of pulleys.

Therefore, effects of the present disclosure are as follows:

First, advantages for employing the servo motor 36:

1. fast response, the servo motor 36 can reach the required speed (more than 2000 RPM) in a short time to reduce waiting time and thus to speed up the floor processing.

2. the servo motor 36 can be used in a wide speed range (3000˜5000 RPM). According to different thickness of floor processing, the required rotation speed can be adjusted to increase the usage of the tools (lifetime) and improve the precision of processing. For example, when the processing range of the elevated floor thickness is increased from 1 mm to 2˜12 mm, the cutting thickness becomes larger and cutting resistance also increases, so cutting heat increases. Thus, the cutting speed can be decreased by adjusting the rotation speed of the servo motor 36.

3. the servo motor 36 can maintain a stable torque at in different rotation speeds, and directly drive the milling tool 30 for processing. Therefore, there is no problem of insufficient torque generated by conventional stepping motors in high load, too much inertia, or increasing of rotation speed and thus the problem of being unable to drive the milling tool. It should be noted that the torque of the conventional stepping motor decreases as the rotation speed increases.

Second, advantages of a direct drive manner in which the servo motor 36 is integrated with the milling tool 30 in a linear manner:

1. More space is saved and the overall dimension of the milling device 3 is smaller.

2. Efficiency can be improved, and power will not be consumed in the reduction mechanism. For example, belts, chains, or components within the gearbox employed in conventional motors rub against each other.

3. Noise can be reduced. The overall configuration of the present disclosure is relatively simple, with few components, thereby not easy to generate vibration so that relatively small noise is generated.

4. Longer lifetime can be provided, and fewer components mean few components prone to be damaged. For example, damages of the conventional processing system mostly come from aging (e.g., stretching of belts) of components or stress.

The above-described descriptions of the detailed embodiments are to illustrate the implementation according to the present disclosure, and it is not to limit the scope of the present disclosure. Accordingly, all modifications and variations completed by those with ordinary skill in the art should fall within the scope of present disclosure defined by the appended claims.

What is claimed is:

1. An edge milling component, comprising:
at least one milling tool;
a support structure of a plate base body for bringing the milling tool to displace linearly;
a carrying structure displaceably disposed on the support structure for carrying the milling tool, wherein the carrying structure and the milling tool are moved close to or away from a target object so as for the milling tool to perform an edge milling machining on the target object; and
at least one motor integrated with the milling tool in a linear manner by a shaft coupling and disposed on the carrying structure to directly drive the milling tool by the shaft coupling.

2. The edge milling component of claim 1, wherein the support structure has a displacement direction perpendicular to a displacement direction of the carrying structure.

3. The edge milling component of claim 1, wherein the support structure has a rail and the carrying structure has at least one sliding block engaged with the rail to move on the rail, thereby causing the carrying structure to displace relative to the support structure.

4. The edge milling component of claim 1, wherein the carrying structure has a ball nut fastened thereon, and a ball screw rod is driven by another motor to rotate to drive the ball nut to move linearly, thereby bringing the carrying structure to move linearly and displacing the milling tool to a required position.

5. The edge milling component of claim 1, wherein the motor is fixed on an upper base body of a shaft coupling base by bolts, and a lower base body of the shaft coupling base is fixed on a milling head of the milling tool by bolts, the shaft coupling is disposed within the shaft coupling base to be pivotally connected to the motor and the milling head, wherein the shaft coupling is a cylindrical structure made of high vibration-absorbing material, and a rotating shaft of the motor is fixed on one end of the shaft coupling while a rotating shaft of the milling head is fixed on the other end of the shaft coupling.

6. The edge milling component of claim 1, wherein the milling tool has a milling cutter at a top of a body of the milling tool.

7. An edge milling device, comprising:
the edge milling component of claim 1;
a base platform having a working surface, wherein the edge milling component is displaceably disposed on the working surface, and wherein the support structure is displaceably disposed on the base platform;
a positioning structure disposed on the working surface for placing the target object, wherein the edge milling component is disposed at a side edge of the positioning structure to displace relative to the positioning structure and perform the edge milling machining on the target object, wherein the target object has a first surface, a second surface opposite to the first surface, a side surface adjacent to and connecting the first and second surfaces, and a flange protruding from the side surface, and each of four corners of the second surface has a foot base; and
a fastening portion disposed corresponding to the positioning structure to press the target object on the positioning structure.

8. The edge milling device of claim 7, wherein the positioning structure is a multi-layer rectangular plate body having a square-shaped placing platform disposed thereon, the target object is placed on the placing platform, such that the edge milling component is respectively placed at four side edges of the placing platform.

9. The edge milling device of claim 8, wherein the edge milling component corresponds to each edge of the placing platform to perform an edge milling machining of the target object.

10. The edge milling device of claim 8, wherein a plurality of the edge milling components on the four side edges of the placing platform perform loop-type displacements.

11. The edge milling device of claim 7, wherein the fastening portion is disposed over the positioning structure and outside one of diagonally opposite corners, or wherein the fastening portion is disposed over the positioning structure or outside one of the diagonally opposite corners.

12. The edge milling device of claim 11, wherein the fastening portion is pressed down or pulled up by a power source to press or separate from the second surface of the target object.

13. The edge milling device of claim 11, wherein a support frame is respectively disposed on front and rear sides of the base platform, and the fastening portion is disposed on a main frame extending on a surface of the support frame, such that boot bases of the target object are tightly hold diagonally by a plurality of the fastening portions.

14. The edge milling device of claim 11, wherein the positioning structure is a multi-layer rectangular plate body having a square-shaped placing platform disposed thereon, the target object is placed on the placing platform, such that the fastening portion is disposed over the placing platform to restrict the displacement of the target object.

15. The edge milling device of claim 14, wherein a support frame is respectively disposed on front and rear sides of the base platform, and an arm frame is disposed on the support frame and pivotally connected to a stand frame, such that the fastening portion is disposed by the stand frame.

16. The edge milling device of claim 7, further comprising a double rail structure fastened on the base platform, and a sliding base fastened on a bottom of the support structure and mounted on the double rail structure, wherein the sliding base slides on the double rail structure, thereby bringing the support structure to move linearly.

17. The edge milling device of claim 7, wherein the support structure has a ball nut fastened thereon, and a ball screw rod is driven by a first motor to rotate to bring the ball nut to move linearly, thereby causing the support structure to move linearly along an edge of the positioning structure relative to the base platform and the milling tool to displace linearly along the side surface of the target object to process the flange of the target object.

18. The edge milling device of claim 7, further comprising a sliding rail disposed on the working surface of the base platform for guiding the support structure to displace.

19. The edge milling device of claim 7, further comprising at least one power unit disposed on the base platform, wherein the power unit comprises a first motor for driving the support structure to displace and a second motor for driving the carrying structure to displace.

20. The edge milling device of claim 7, wherein the support structure is a plate base body and is displaceably disposed on the working surface of the base platform.
